(19) United States
(12) Patent Application Publication
(10) Pub. No.: US 2013/0322712 A1
(43) Pub. Date: Dec. 5, 2013

(54) System for Comparing Medical Images

(71) Applicants: David Janes, Rolling Meadows, IL (US); Shailaja Merugu, Carpentersville, IL (US)

(72) Inventors: David Janes, Rolling Meadows, IL (US); Shailaja Merugu, Carpentersville, IL (US)

(73) Assignee: SIEMENS MEDICAL SOLUTIONS USA, INC., Malvern, PA (US)

(21) Appl. No.: 13/889,390

(22) Filed: May 8, 2013

Related U.S. Application Data
(60) Provisional application No. 61/655,543, filed on Jun. 5, 2012.

(51) Int. Cl. G06T 7/00

(52) U.S. Cl. CPC G06T 7/0012
USPC 382/128

(57) ABSTRACT

A system compares gray scale medical images and provides a composite color image for display on a monitor. The system substitutes one or two of the RGB components of a first image with a corresponding RGB component of a second image to provide RGB pixel luminance value component data representing a composite image in color. An acquisition processor acquires first and second gray scale medical images represented by RGB pixel luminance value components. An image data processor aligns the first and second gray scale medical images and substitutes one of the RGB components of the first image with a corresponding RGB component of the second image to provide RGB pixel luminance value component data representing a composite image in color. An output processor outputs the composite image for display.

This is a non-provisional application of provisional application serial No. 61/655,543 filed Jun. 5, 2012, by D. Janes et al.

### FIELD OF THE INVENTION

This invention concerns a system for comparing gray scale medical images and providing a composite color image for display on a monitor.

### BACKGROUND OF THE INVENTION

In performing a medical procedure, normally digital medical images are taken before the procedure and digital images are taken after the procedure. It is often found useful to compare the ‘before’ images with the ‘after’ images. Known systems offer limited capabilities for enabling visual comparison of medical images including before and after images. A system according to invention principles addresses this deficiency and related problems.

### SUMMARY OF THE INVENTION

A system compares gray scale medical images and provides a composite color image for display on a monitor. The system substitutes one of the RGB components of a first image with a corresponding RGB component of a second image to provide RGB pixel luminance value component data representing a composite image in color. An acquisition processor acquires first and second gray scale medical images represented by RGB pixel luminance value components. An image data processor aligns the first and second gray scale medical images and substitutes one of the RGB components of the first image with a corresponding RGB component of the second image to provide RGB pixel luminance value component data representing a composite image in color. An output processor outputs the composite image for display.

### BRIEF DESCRIPTION OF THE DRAWING

FIG. 1 shows a system for comparing gray scale medical images and providing a composite color image for display on a monitor, according to invention principles.

FIG. 2 shows a gray scale image of a vessel before a procedure showing a narrow lumen.

FIG. 3 shows a gray scale image of a vessel after a procedure showing the lumen of FIG. 2 has been expanded.

FIG. 4 shows a gray scale image (representing a color image) corresponding to the image of FIG. 2 of the vessel before a procedure showing a narrow lumen, according to invention principles.

FIG. 5 shows a gray scale image (representing a color image) corresponding to the image of FIG. 3 of the vessel after a procedure showing an expanded lumen, according to invention principles.

FIG. 6 shows a gray scale image (representing a composite color image) that combines RGB color luminance intensities of the image bitmaps of FIGS. 4 and 5, according to invention principles.

FIG. 7 shows a flowchart of a process used by a system for comparing gray scale medical images and providing a composite color image for display on a monitor, according to invention principles.

### DETAILED DESCRIPTION OF THE INVENTION

A system compares different first and second gray scale medical images represented as RGB component luminance values by substituting one of the RGB components of the first image with a corresponding RGB component of the second image to provide a composite image in color. In another embodiment, the system substitutes two of the RGB components of the first image with corresponding two RGB components of the second image.

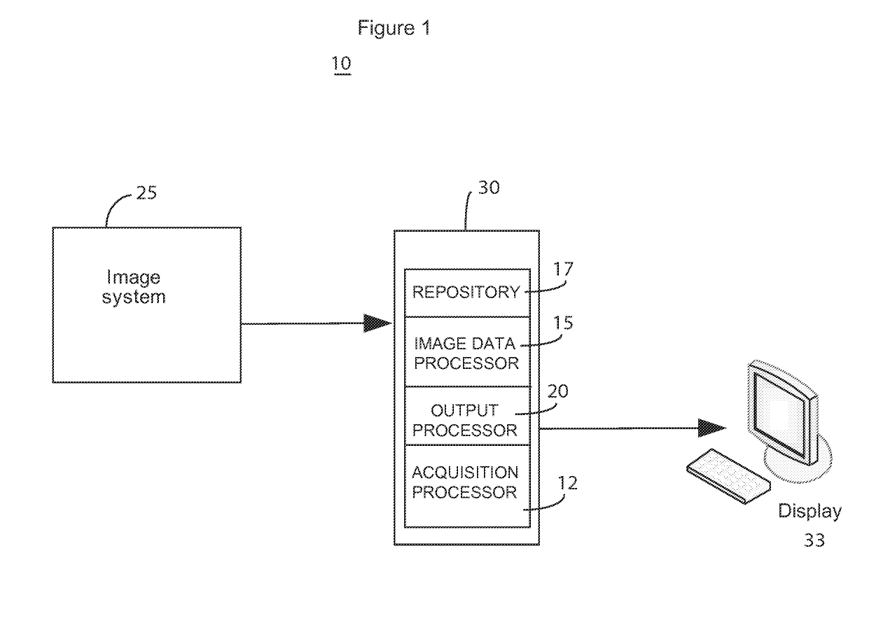

FIG. 1 shows system 10 for comparing gray scale medical images and providing a composite color image for display on monitor 33. System 10 employs at least one processing device 30 for processing images acquired by imaging system 25 for display on monitor 33. Specifically, processing device 30 comprises at least one computer, server, microprocessor, programmed logic device or other processing device comprising repository 17, image data processor 15, output processor 20 and acquisition processor 12.

Acquisition processor 12 acquires first and second gray scale medical images from imaging system 25 such as an MR, X-ray, CT scan or ultrasound imaging system. The first and second gray scale medical images are represented by RGB pixel luminance value components. Image data processor 15 aligns the first and second gray scale medical images and substitutes one of the RGB components of the first image with a corresponding RGB component of the second image to provide RGB pixel luminance value component data representing a composite image in color. Output processor 20 outputs the composite image for display on monitor 33. In another embodiment, image data processor 15 substitutes two of the RGB components of the first image with corresponding two RGB components of the second image to provide RGB pixel luminance value component data representing a composite image in color.

X-Ray Angiography images are typically gray scale images. This means that each pixel in an image is represented with equal intensities of the three primary colors: red, green, and blue (R, G, B). For n-bit gray scale, black is represented by a value of zero for each of the three primary colors and white is represented by a value of 2ⁿ-1 for each of the three primary colors. Different shades of grey are represented by varying the equal color intensities from zero to 2ⁿ-1 for the three primary colors. So, for example, medium grey is represented by equal intensities of 2⁽ⁿ⁻¹⁾ for the three primary colors. So each pixel is represented by a RGB (red-green-blue) color combination. White is RGB(2ⁿ-1, 2ⁿ-1, 2ⁿ-1), black is RGB(0, 0, 0), and medium grey is RGB(2⁽ⁿ⁻¹⁾, 2⁽ⁿ⁻¹⁾, 2⁽ⁿ⁻¹⁾. Light Grey is (2⁽ⁿ⁻²⁾, 2⁽ⁿ⁻²⁾, 2⁽ⁿ⁻²⁾). Dark grey is (3*2⁽ⁿ⁻²⁾, 3*2⁽ⁿ⁻²⁾, 3*2⁽ⁿ⁻²⁾.

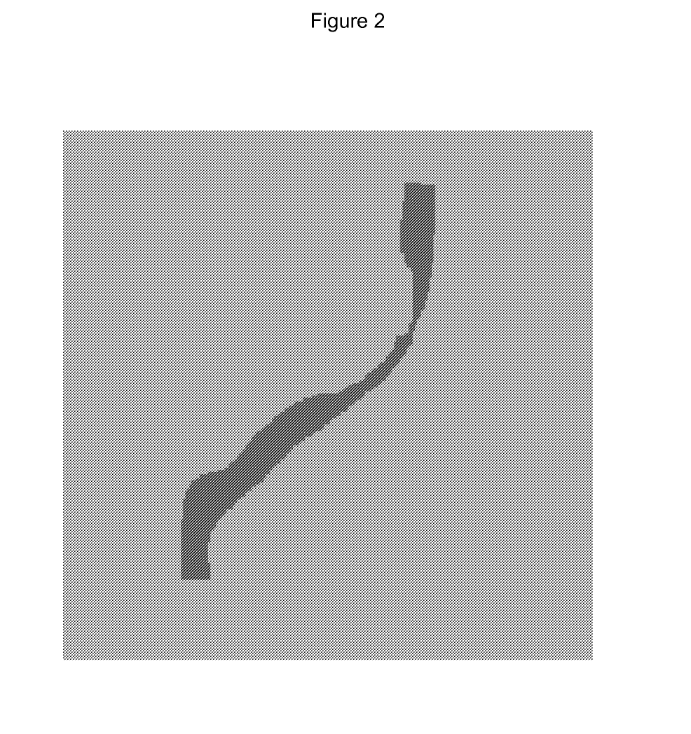

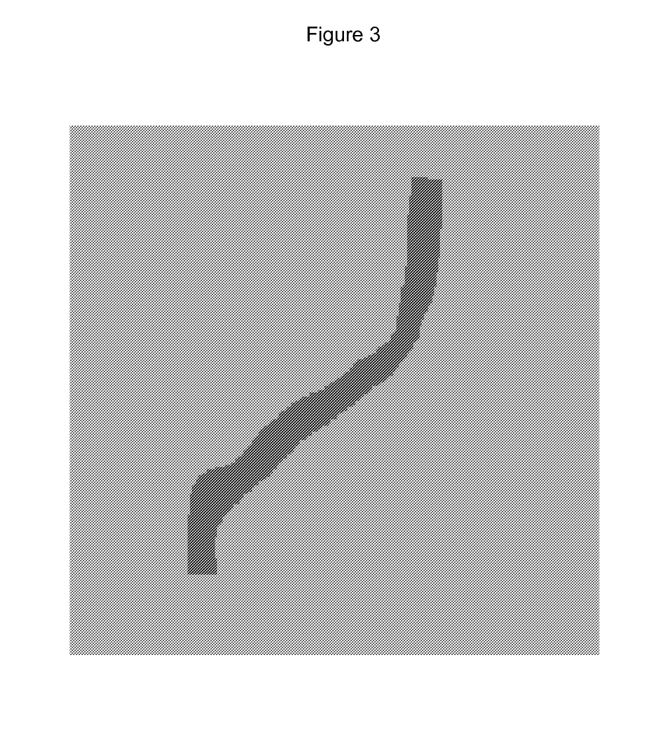

In performing a medical procedure, there are normally digital images taken before the procedure is performed and digital images taken afterwards. FIG. 2 shows an example gray scale image of a vessel before a procedure showing a narrow lumen in a gray scale bitmap. This represents an eight bit color depth image with only two shades of gray: (RGB(128,128,128)) and (RGB(192,192,192)). In the general case, there are many different shades of gray, say (RGB(b,b,b)) for any particular pixel. FIG. 3 shows a gray scale image of a vessel after a procedure showing the lumen of FIG. 2 has been expanded in a grey scale bitmap. This represents an eight-bit color depth diagram with only two shades of gray: (RGB(128, 128, 128)) and (RGB(192,192,192)). In the general case, there are multiple different shades of gray, say (RGB(a, a, a)) used throughout the image.

It is useful to compare the ‘before’ images with the ‘after’ images. The inventors have recognized each of the images may be advantageously viewed in varying shades of a color. For example, instead of using gray, one image is represented in varying shades of yellow (in which the red and green intensities are equal and the blue intensity is zero) and another image is represented in blue with red and green intensities zero. For example, any pixel of the first (before) image represented previously as RGB(b, b, b) is represented as RGB(b, b, 0). Likewise, a second pixel of a second (after) image corresponding to the first pixel of the first image, represented previously as RGB(a, a, a) is shown as RGB(0, 0, a). Therefore, each pixel of the first image represented previously as RGB(b, b, b) is shown as RGB(b, b, 0) with red and green color and each pixel of the second image represented previously as RGB(a, a, a) is shown as RGB(0, 0, a) with blue color.

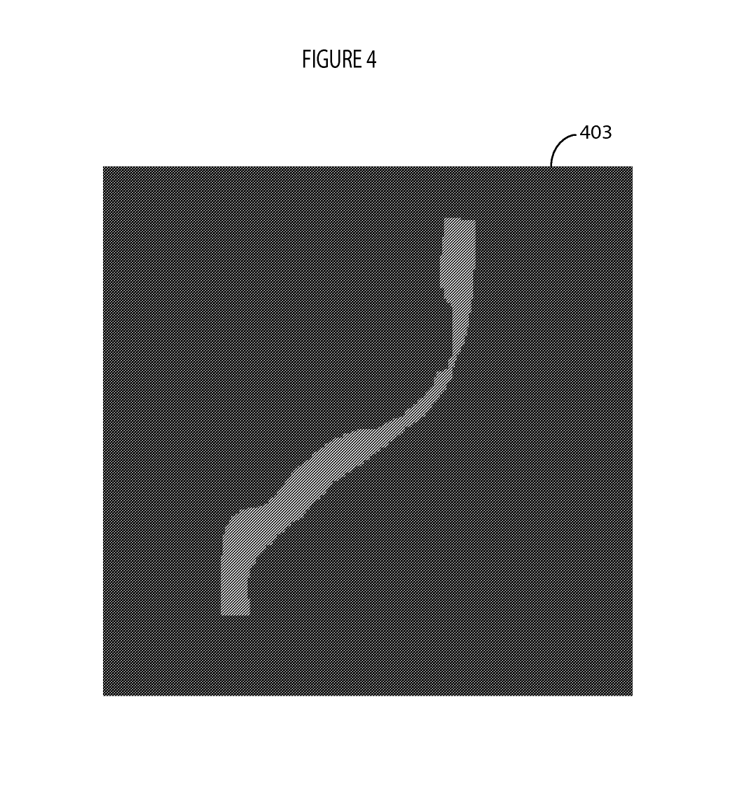

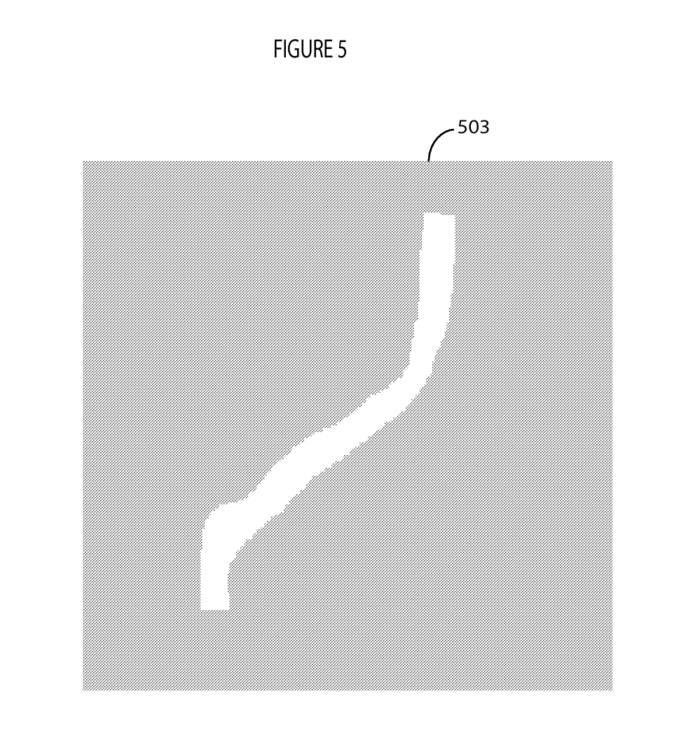

System 10 (FIG. 1) generates the FIG. 4 gray scale image 403 (representing a color image) corresponding to the image of FIG. 2 of the vessel before a procedure showing a narrow lumen by replacing the RGB(b, b, b) individual pixel values of FIG. 2 with RGB(b,b,0) pixel values. In image 403 each pixel represented previously as RGB(b, b, b) is shown as RGB(b, b, 0) with red and green colors present comprising a yellow shade. In the example of FIG. 4, there are only two shades of yellow: (RGB(128, 128, 0)) and (RGB(192, 192, 0)). In the general case, there are multiple shades of yellow used throughout the image. System 10 generates the FIG. 5 gray scale image 503 (representing a color image) corresponding to the image of FIG. 3 of the vessel after a procedure showing an expanded lumen by replacing the RGB(a,a,a) individual pixel values with RGB(0, 0, a) pixel values. In image 503 each pixel represented previously as RGB(a, a, a) is shown as RGB(0, 0, a) with blue color. In FIG. 5, there are only two shades of blue: RGB(0, 0, 128) and RGB(0, 0, 192). In the general case, there are multiple shades of blue used throughout the image.

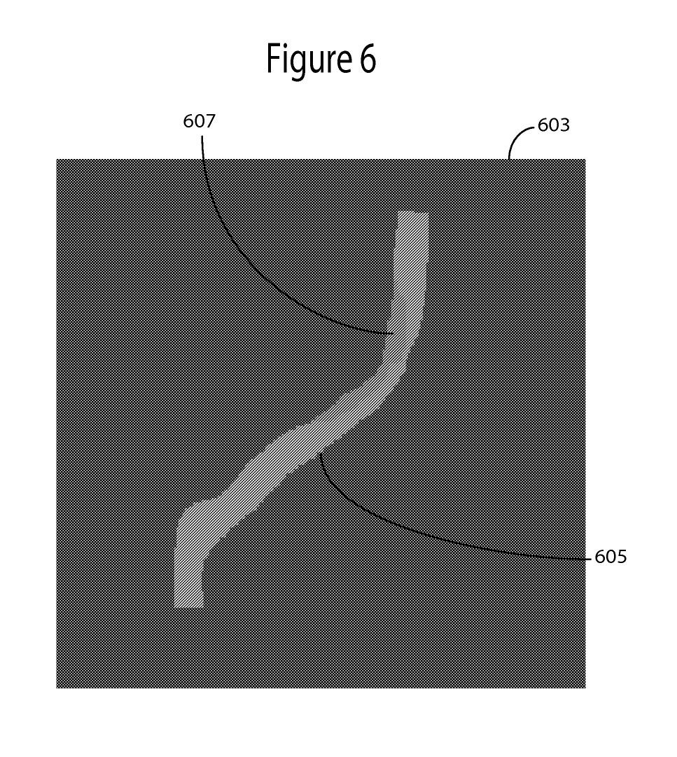

FIG. 6 shows gray scale image 603 (representing a composite color image) that combines RGB color luminance intensities of the image bitmaps of FIGS. 4 and 5. System 10 (FIG. 1) generates image 603 by combining the images of FIGS. 4 and 5 into composite image 603 where each pixel is represented with the color intensities from the ‘before’ image FIG. 4 added to the color intensities from the ‘after’ image FIG. 5. Therefore, if the original pixel at position (x, y) from the ‘before’ image has a gray scale value of RGB(i1, i1, i1) and if the pixel at the same (x, y) position from the ‘after’ image has a grey scale value of RGB(i2, i2, i2), the pixel on the combined image at the (x, y) position is RGB(i1, i1, i2). Therefore system 10 generates image 603 including the narrowed lumen portion 605 of the before image 403 in gray because the red, green, and blue intensities are equal with the expanded lumen portion 607 in color because the blue intensity differs from red and green intensities. An individual pixel of the composite bitmap image 603 combines red and green intensities of a bitmap image 403 pixel with the blue intensity of a bitmap image 503 pixel. Specifically, a pixel RGB=(X, X, 0) value of image 403 and the RGB=(0, 0, Y), value of a corresponding pixel in the same position in image 503 are combined to provide an RGB=(X, X, Y) value of a pixel in composite image 603.

System 10 adaptively transforms (zooms (scales), rotates and translates) image 403 relative to image 503 so image 403 covers the same number of screen pixels as image 503 and the images are mutually aligned so that objects common to both images 403 and 503 are in the same corresponding place on a screen. Display 33 advantageously presents composite image 603 enabling a user to view and compare before and after image features in a single image. Specifically, image 603 shows increased lumen size (607) with color pixel values RGB=(128, 128, 192).

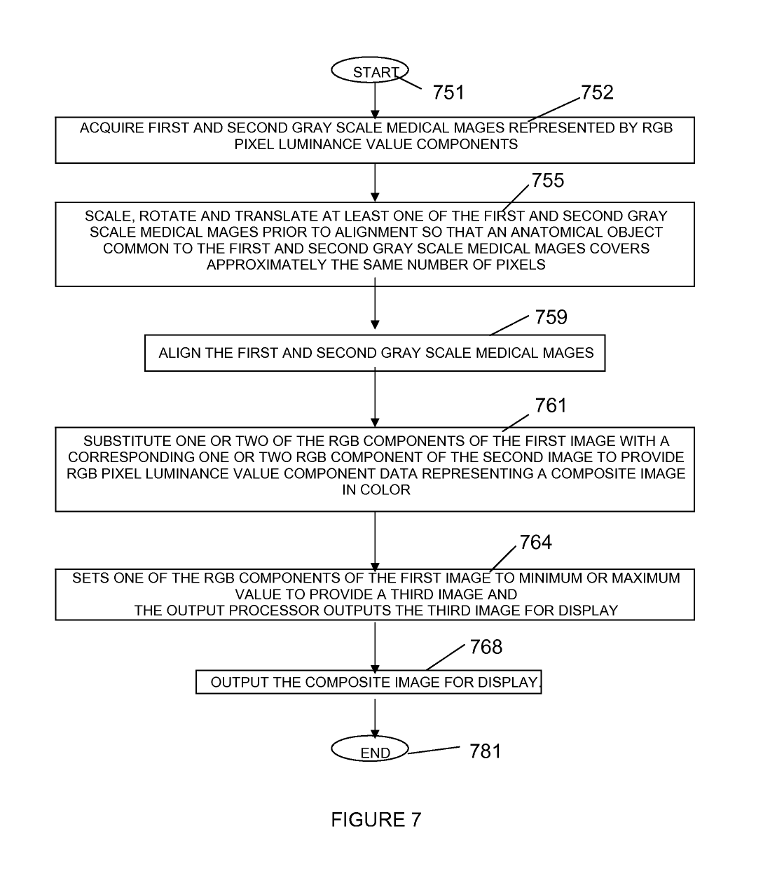

FIG. 7 shows a flowchart of a process used by system 10 (FIG. 1) for comparing gray scale medical images and providing a composite color image for display on monitor 33. In step 752 following the start at step 751, acquisition processor 12 acquires first and second gray scale medical images represented by RGB pixel luminance value components. Image data processor 15 in step 755 transforms by scaling (zooming), rotating and translating at least one of the first and second gray scale medical images prior to alignment. Specifically, processor 15 transforms by performing at least one of, scaling, rotating, zooming, and/or translation to the first and second gray scale medical images prior to alignment so that an anatomical object common to the first and second gray scale medical images covers approximately the same number of pixels.

Image data processor 15 in step 759 aligns the transformed first and second gray scale medical images. In step 761 processor 15 substitutes one of the RGB components of the first image with a corresponding RGB component of the second image to provide RGB pixel luminance value component data representing a composite image in color. In one embodiment, processor 15 substitutes two of the three RGB components of the first image with corresponding RGB components of the second image to provide RGB pixel luminance value component data representing a composite image in color. In another embodiment, processor 15 substitutes one of the RGB components of the first image with the corresponding RGB value of the second image or in a further embodiment a weighted summation of one or more RGB values. Processor 15 in step 764 sets one of the RGB components of the first image to a minimum or maximum value to provide a third image. In step 768 output processor 20 outputs the composite image and the third image for display on unit 33. The process of FIG. 7 terminates at step 781.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. Computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s). A user interface processor or generator is a known element comprising electronic circuitry or software or a combination of both for generating display elements or portions thereof. A user interface comprises one or more display elements enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display elements, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the elements for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display elements in response to signals received from the input devices. In this way, the user interacts with the display elements using the input devices, enabling user interaction with the processor or other device. The functions and process steps herein may be performed automatically or wholly or partially in response to user command. An activity (including a step) performed automatically is performed in response to executable instruction or device operation without user direct initiation of the activity. A histogram of an image is a graph that plots the number of pixels (on the y-axis herein) in the image having a specific intensity value (on the x-axis herein) against the range of available intensity values. The resultant curve is useful in evaluating image content and can be used to process the image for improved display (e.g. enhancing contrast).

The system and processes of FIGS. 1-7 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system compares different first and second gray scale medical images represented as RGB component luminance values by substituting one or two of the RGB components of the first image with corresponding one or two of the RGB component of the second image to provide a composite image in color. Further, the processes and applications may, in alternative embodiments, be located on one or more (e.g., distributed) processing devices on a network linking the units FIG. 1. Any of the functions and steps provided in FIGS. 1-7 may be implemented in hardware, software or a combination of both. No claim element herein is to be construed under the provisions of 35 U.S.C. 112, sixth paragraph, unless the element is expressly recited using the phrase “means for.”

What is claimed is:

1. A system for comparing gray scale medical images and providing a composite color image for display on a monitor, comprising:
an acquisition processor for acquiring first and second gray scale medical images represented by RGB pixel luminance value components;
an image data processor for,
aligning the first and second gray scale medical images and
substituting one of the RGB components of the first image with a corresponding RGB component of the second image to provide RGB pixel luminance value component data representing a composite image in color; and
an output processor for outputting the composite image for display.

2. A system according to claim 1, wherein
said image data processor substitutes two of the three RGB components of the first image with corresponding RGB components of said second image to provide RGB pixel luminance value component data representing a composite image in color.

3. A system according to claim 1, wherein
said image data processor scales at least one of said first and second gray scale medical images prior to alignment.

4. A system according to claim 3, wherein
said image data processor scales at least one of said first and second gray scale medical images prior to alignment so that an anatomical object common to said first and second gray scale medical images covers approximately the same number of pixels.

5. A system according to claim 1, wherein
said image data processor rotates at least one of said first and second gray scale medical images prior to alignment.

6. A system according to claim 1, wherein
said image data processor translates at least one of said first and second gray scale medical images prior to alignment.

7. A system according to claim 1, wherein
said image data processor sets one of the RGB components of the first image to minimum or maximum value to provide a third image and
said output processor outputs the third image for display.

8. A method for comparing gray scale medical images and providing a composite color image for display on a monitor, comprising the activities of:
acquiring first and second gray scale medical images represented by RGB pixel luminance value components;
aligning the first and second gray scale medical images;
substituting one of the RGB components of the first image with a corresponding RGB component of the second image to provide RGB pixel luminance value component data representing a composite image in color; and
outputting the composite image for display.

9. A method according to claim 8, including the activity of
substituting two of the three RGB components of the first image with corresponding RGB components of said second image to provide RGB pixel luminance value component data representing a composite image in color.

10. A method according to claim 8, including the activity of
scaling at least one of said first and second gray scale medical images prior to alignment.

11. A method according to claim 10, including the activity of
scaling at least one of said first and second gray scale medical images prior to alignment so that an anatomical object common to said first and second gray scale medical images covers approximately the same number of pixels.

12. A method according to claim 8, including the activity of
rotating at least one of said first and second gray scale medical images prior to alignment.

13. A method according to claim 8, including the activity of
translating at least one of said first and second gray scale medical images prior to alignment.

14. A method according to claim 1, including the activities of
setting one of the RGB components of the first image to minimum or maximum value to provide a third image and
outputting the third image for display.

15. A non-tangible storage medium comprising computer executable instructions for performing a method for comparing gray scale medical images and providing a composite color image for display on a monitor, comprising the activities of:
acquiring first and second gray scale medical images represented by RGB pixel luminance value components;
aligning the first and second gray scale medical images;
substituting one of the RGB components of the first image with a corresponding RGB component of the second image to provide RGB pixel luminance value component data representing a composite image in color; and
outputting the composite image for display.
